(19) United States
(12) Patent Application Publication
(10) Pub. No.: US 2013/0117574 A1
(43) Pub. Date: May 9, 2013

(54) MEMORY DEVICE AND SYSTEM WITH SECURE KEY MEMORY AND ACCESS LOGIC

(71) Applicants: HYOUNG-SUK JANG, GWANGMYEONG-SI (KR); HEE-CHANG CHO, SEOUL (KR)

(72) Inventors: HYOUNG-SUK JANG, GWANGMYEONG-SI (KR); HEE-CHANG CHO, SEOUL (KR)

(73) Assignee: SAMSUNG ELECTRONICS CO., LTD., Suwon-si (KR)

(21) Appl. No.: 13/599,047

(22) Filed: Aug. 30, 2012

(30) Foreign Application Priority Data
Nov. 4, 2011 (KR) 10-2011-0114633

(51) Int. Cl. G06F 12/14

(52) U.S. Cl. 713/189; 726/19

(57) ABSTRACT

A memory device includes a first memory area that stores a secure key, a second memory area that stores content data, memory secure logic configured to exclusively access the secure key in the first memory area, and a memory controller, physically separate from the memory secure logic, that accesses the content data in response to externally provided command, address and data (CAD) information and the secure key as accessed through the memory secure logic.

### CROSS-REFERENCE TO RELATED APPLICATION

This application claims priority under 35 U.S.C. 119 from Korean Patent Application No. 10-2011-0114633 filed on Nov. 4, 2011, the subject matter of which is hereby incorporated by reference.

### BACKGROUND OF THE INVENTION

The inventive concept relates generally to memory devices and memory systems including one or more memory devices. More particularly, the inventive concept relates memory devices and memory systems capable of storing a security key in a dedicated memory and being accessed by specialized access logic.

Contemporary data systems and consumer electronics make use of an expanding array of data storage devices. For example, memory cards based on flash memory or universal serial bus (USB) memories connectable via a USB port are commonly used. More recently, so-called solid state drives (SSDs) has been introduced and are increasingly used in place of hard disk drives (HDD). These emerging memory systems provided greatly expanded data storage volume with reduced physical size and faster data access speeds.

However, effective connection interfaces between the storage devices and various host devices must be provided that facilitate the attachment/de-attachment of portable storage devices. Even contemporary HDDs, still one of the cheapest storage devices, are often provided as “external” data storage devices in order to facilitate mobility of stored data between platforms. Furthermore, like emerging storage devices, many host devices are shrinking in size and are being designed with greater portability in mind.

Unfortunately, ready changeability of stored data, the portability of data between storage devices, and various interconnections between storage devices and host devices creates a number of problems related to data security.

### SUMMARY OF THE INVENTION

Embodiments of the inventive concept provide memory devices and memory systems providing improved security.

According to an aspect of the inventive concept, there is provided a memory device comprising; a first memory area that stores a secure key, a second memory area that stores content data, memory secure logic configured to exclusively access the secure key in the first memory area, and a memory controller, physically separate from the memory secure logic, that accesses the content data in response to externally provided command, address and data (CAD) information and the secure key as accessed through the memory secure logic.

According to another aspect of the inventive concept, there is provided a memory system comprising a memory device and a host device configured to access the memory device. The memory device comprises a first memory area that stores a secure key, a second memory area that stores content data, memory secure logic configured to exclusively access the secure key in the first memory area, and a memory controller, physically separate from the memory secure logic, that accesses the content data in response to externally provided command, address and data (CAD) information and the secure key as accessed through the memory secure logic.

According to another aspect of the inventive concept, there is provided a method of operating a memory system including a memory device, and a host device configured to access content data stored in the memory device, wherein the memory device includes a memory controller and memory secure logic physically separate from the memory controller. The method comprises; storing a secure key in a first memory area of the memory device, and storing content data in a second memory area of the memory device, communicating control, address and data (CAD) information from the host device to the memory controller, and in response to the CAD information, using the memory controller to control operation of the memory secure logic to exclusively access the secure key, wherein access to the content data by the host device requires both the CAD information and execution of access rights granted by the secure key

### BRIEF DESCRIPTION OF THE DRAWINGS

The above and other aspects and features of the inventive concept will become more apparent upon consideration of certain exemplary embodiments thereof with reference to the attached drawings, in which:

FIG. 1 is a block diagram of a memory device in accordance with embodiments of the inventive concept;

FIG. 2 is a conceptual diagram further illustrating operation of a memory device in accordance with embodiments of the inventive concept;

FIG. 3 is a block diagram further illustrating a memory system in accordance with embodiments of the inventive concept;

FIG. 4 is a diagram further illustrating operation of the memory system in accordance with embodiments of the inventive concept;

FIG. 5 is a diagram still further illustrating operation of a memory system in accordance with embodiments of the inventive concept;

FIG. 6 is a block diagram generally illustrating a memory system in accordance with embodiments of the inventive concept;

FIG. 7 is a block diagram illustrating one possible application of the memory system of FIG. 6; and

FIG. 8 is a block diagram illustrating a computational system including the memory system described with reference to FIG. 7.

### DETAILED DESCRIPTION

Certain embodiments of the inventive concept will now be described in some additional detail with reference to the accompanying drawings. The inventive concept may, however, be embodied in different forms and should not be construed as being limited to only the illustrated embodiments. Rather, the embodiments are provided so that this disclosure will be thorough and complete, and will fully convey the scope of the inventive concept to those skilled in the art. Throughout the written description and drawings like reference numbers and labels are used to denote like or similar elements and/or features.

The use of the terms “a” and “an” and “the” and similar referents in the context of describing the inventive concept (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this inventive concept belongs. It is noted that the use of any and all examples, or exemplary terms provided herein is intended merely to better illuminate the inventive concept and is not a limitation on the scope of the inventive concept unless otherwise specified. Further, unless defined otherwise, all terms defined in generally used dictionaries may not be overly interpreted.

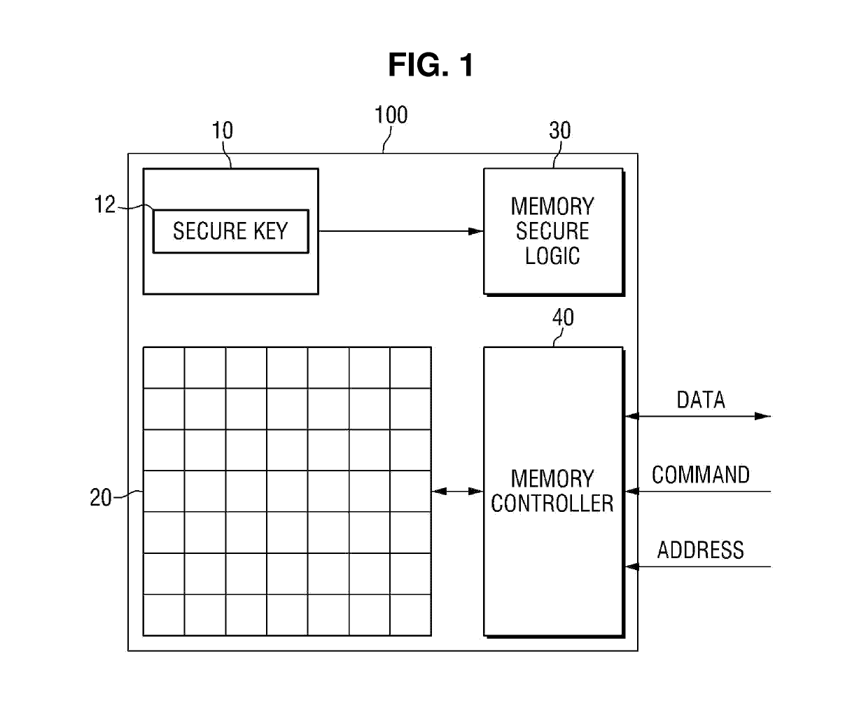

Figure (FIG. 1 is a block diagram of a memory device in accordance with certain embodiments of the inventive concept. Referring to FIG. 1, a memory device 100 generally comprises a first (dedicated) memory area 10, a second (general) memory area 20, a (dedicated) memory security logic unit 30 and a (general) memory controller 40.

One or more secure key(s) 12 (hereafter, referred to in the singular “secure key” for the sake of clarity, but recognizing that more than one secure key(s) may be implicated in embodiments of the inventive concept) is specifically stored in the dedicated memory area 10, while all other data types (hereafter, collectively referred to as “content data”) are stored in the general memory area 20.

In the embodiment illustrated in FIG. 1, the secure key 12 stored in the dedicated memory area 10 may be a key used for authentication when, e.g., a host device (not shown) accesses content data stored in the general memory area 20. Specifically, the secure key 12 stored in the dedicated memory area 10 may be a key associated with the control of playback time or a number of playbacks for the content data stored in the general memory area 20, such as a key associated with digital rights management (DRM).

Here, the content data (e.g., music, video, document, image and/or computer program) stored in the general memory area 20 may is accessed only in relation to the secure key 12 stored in the dedicated memory 10. Further, “accessing” (e.g., reading, writing, changing, updating, communicating and/or transferring) of the content data by the host device may include displaying or printing all or part of the content data in the form of image and document, playing back the content data in the form of music and video, and installing or executing the content data in the form of application such as computer program.

In the illustrated embodiment of FIG. 1, access right(s) to the dedicated memory area 10 storing the secure key 12 is singularly assigned to the memory secure logic unit 30 and not to the general memory controller 40. In this regard, the memory secure logic is said to be “specialized” in its secure key access capabilities, while the general memory controller 40 is able to access only the content data. As is conventionally understood, the memory controller 40 receives command, address, and/or data information (hereafter, “CAD information”) from an external source (e.g., the host device). Such externally provided CAD information, however, is not in and of itself capable of accessing the content data stored in the general memory area 20 and/or the secure key 12 stored in the dedicated memory area 10. Accordingly, a host device connected to the memory device enjoys no “direct access” capabilities to stored data.

Rather, access to the content data stored in the memory device 100 is only “indirect” in response to the CAD information, as the secure key 12 stored in the dedicated memory area 10 must be used (“invoked”) in conjunction with the CAD information. However, access rights to the stored secure key are granted only through the memory secure logic 30 and not through the memory controller 40. In various embodiments of the inventive concept, the dedicated (first) memory area 10 and the general (second) memory area 20 may be physically (i.e., embodied in physically separate circuits) and/or logically (i.e., commonly embodied in the same physical circuit but separately accessed by different CAD information) from one another.

With this configuration, the memory device 100 precludes “hacking” of the content data by a user obtaining the secure key by interception and analysis of some portion of the CAD information. Thus, in a case where the content data stored in the general memory area 20 is externally transferred to another storage device (e.g., a separate NAND flash, NOR flash, hard disk, solid state drive (SSD) or the like in which the secure key 12 is not stored), a subsequently connected host device will not be able to access the transferred content data. Thus, it is possible to achieve copy protection of the content data, thereby improving the security provide by the memory device 100.

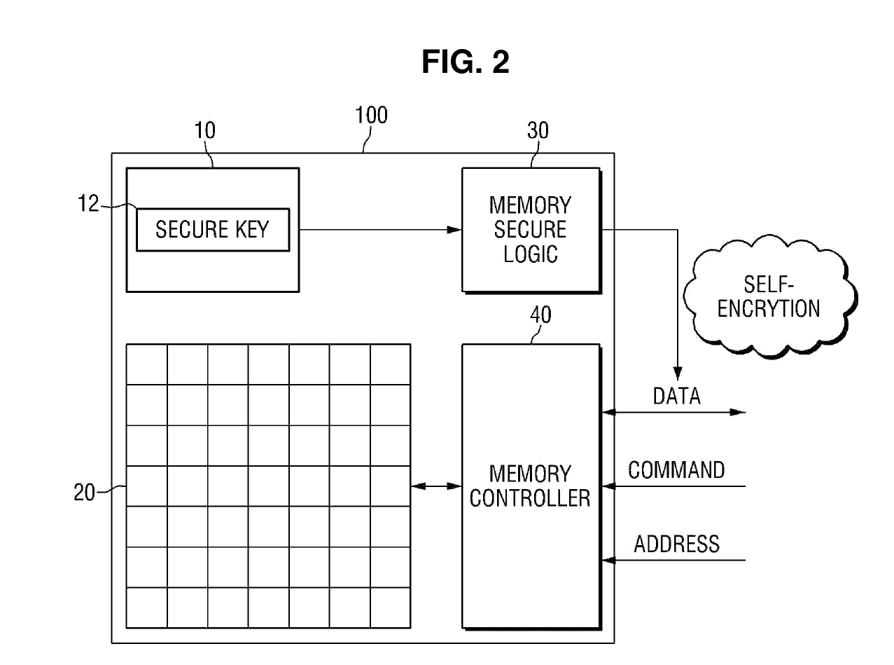

In certain embodiments of the inventive concept, the secure key 12 stored in the dedicated memory area 10 may be used during self-encryption of the memory device 100. FIG. 2 is a conceptual diagram further illustrating operation of a memory device in accordance with the embodiment of the inventive concept providing a self-encryption function.

Referring to FIG. 2, the secure key 12 stored in the first memory area 10 may be used in the self-encryption of the content data stored in the second memory area 20. Specifically, the memory secure logic unit 30 may encrypt data inputted into the memory device 100 from the outside (e.g., host device (not shown)) using the secure key 12 stored in the first memory area 10 and provide the encrypted input data to the memory controller 40. Upon receipt of the encrypted input data, the memory controller 40 may store the encrypted input data as the content data in the second memory area 20 referring to an address inputted together.

When a command requesting access to content data is received from an external device (e.g., host device), the memory controller 40 outputs the encrypted content data from the second memory area 20 as indicated by address information. In this case, the memory secure logic unit 30 may decrypt the data received from the memory controller 40 using the secure key 12, such that decrypted content data is provided to the external device.

Although a case where the secure key 12 stored in the first memory area 10 is used in digital rights management (DRM) and a case where the secure key 12 is used in the self-encryption of the memory device 100 have been described in the embodiment, the inventive concept is not limited to the above-described exemplary cases. Regardless of the contents of the secure key 12 stored in the first memory area 10, in the memory device 100 in accordance with the embodiments of the inventive concept, the first memory area 10 and the second memory area 20, as may be physically and/or logically independent of each other, and only the memory secure logic unit 30 of the memory controller 40 and the memory secure logic unit 30 disposed in the memory device 100 has an access right to the first memory area 10 storing the secure key 12, thereby improving the security provided by the memory device 100 and/or a memory system including same.

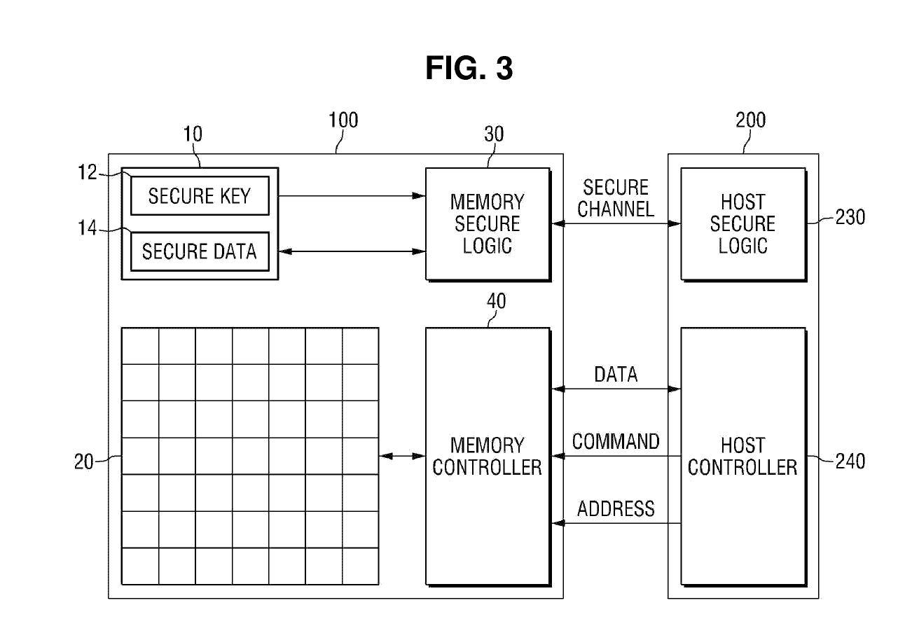

FIG. 3 is a block diagram illustrating a memory system in accordance with embodiments of the inventive concept.

Referring to FIG. 3, the memory system may include a memory device 100 and a host device 200. The memory device 100 may be like the memory device 100 in accordance with the above-described embodiments of the inventive concept. However, in this case, secure data 14 may be stored together with the secure key 12 in the first memory area 10 of the memory device 100. Since the other configuration of the memory device 100 may substantially the same as the above-described embodiment, a detailed description thereof is omitted.

The secure key 12 may include a vender key used in the secure authentication associated with a manufacturer of the memory device 100, and an ID key used in the secure authentication for the memory device 100. Further, the secure data 14 may be data associated with the ID key, i.e., data provided to the host device 200 to perform the secure authentication for the memory device 100. In the illustrated embodiment of FIG. 3, the secure data 14 may be provided to the host device 200 via a secure channel. A detailed description thereof will be given later.

It should be further noted that the memory device 100 may be, e.g., a NAND flash memory device in this embodiment, the inventive concept is not limited thereto.

The host device 200 may be a device capable of being connected to the memory device 100 in order to access content data stored in the memory device 100. The host device 200 may be manufactured as a mobile device such as a mobile phone, PDA, and MP3 player, and a fixed device such as a desktop computer, and digital TV.

The host device 200 and the memory device 100 transmit/receive data to/from each other through various interfaces. Here, the interface may mean a physical part supporting data transmission and reception when a certain device is attached to a connector or another device. In certain embodiments, the interface may be an interface in a general-purpose data communication mode, e.g., serial peripheral interface (SPI), universal serial bus (USB), AT attachment (ATA), Serial ATA (SATA) or integrated drive electronics (IDE).

The host device 200 may include a host secure logic unit 230 and a host controller 240.

The host secure logic unit 230 may perform authentication for the memory device 100. Specifically, the host secure logic unit 230 may create a secure channel through a specific procedure in cooperation with the memory secure logic unit 30 disposed in the memory device 100, and transmit and receive the secure data 14 associated with the secure key 12 to and from the memory secure logic unit 30 through the secure channel, thereby performing the secure authentication for the memory device 100. A detailed description thereof will be given later.

When the host secure logic unit 230 has completed the secure authentication for the memory device 100, the host controller 240 may output a command requesting output of content data stored at a specific address of the second memory area 20 to the memory controller 40 of the memory device 100. Upon receipt of the command and address information, the memory controller 40 may provide the content data stored in the second memory area 20 corresponding to the address to the host controller 240. In this case, the content data provided to the host controller 240 may be, as described above, data outputted after the data which is self-encrypted and stored in the second memory area 20 is decrypted by the memory secure logic unit 30.

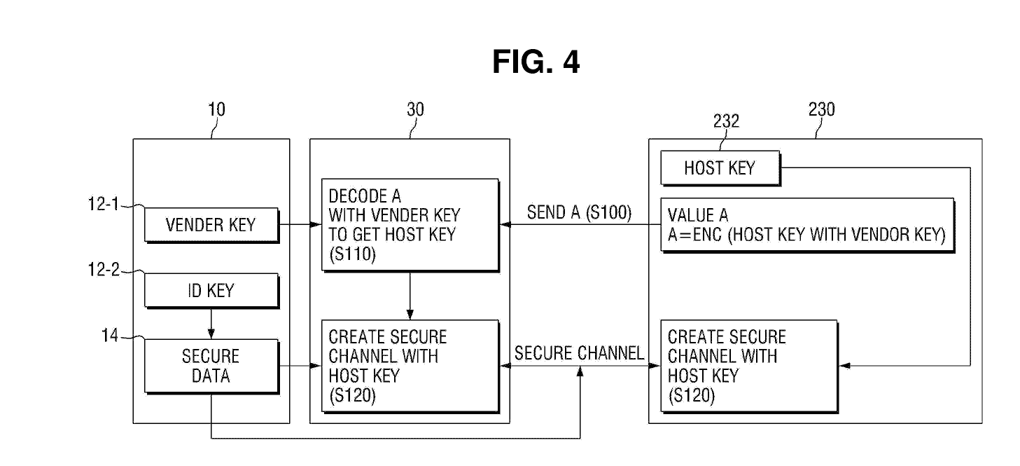

Hereinafter, a method of operating a memory system in accordance with the embodiment of the inventive concept will be described in detail with reference to FIG. 4.

FIG. 4 is a diagram further illustrating operation of the memory system in accordance with embodiments of the inventive concept.

Referring to FIG. 4, the host secure logic unit 230 may include a host key 232. In other words, the host key 232 may be stored in a specific storage area (not shown) in the host secure logic unit 230. Meanwhile, the host secure logic unit 230 may include a first set value “A” obtained by encoding (e.g., encrypting) the host key using a vender key 12-1 of the memory device 100 from the outside (e.g., licensing company). In other words, the first set value A obtained by encoding (e.g., encrypting) the host key using the vender key 12-1 of the memory device 100 may be stored in a specific area (not shown) in the host secure logic unit 230.

Referring again to FIG. 4, the host secure logic unit 230 transmits the first set value A to the memory secure logic unit 30 (S100). Here, the host secure logic unit 230 may transmit the first set value A to the memory secure logic unit 30 using an interface in a general-purpose data communication mode, e.g., serial peripheral interface (SPI), universal serial bus (USB), AT attachment (ATA), Serial ATA (SATA) or integrated drive electronics (IDE).

Upon receipt of the first set value A, the memory secure logic unit 30 decodes (e.g., decrypts) the first set value A using the vender key 12-1 stored in the first memory area 10 (S110). When the first set value A is decoded (e.g., decrypted), the memory secure logic unit 30 may acquire the host key 232 stored in the host secure logic unit 230.

Now that the memory secure logic unit 30 and the host secure logic unit 230 have had the same host key 232, the memory secure logic unit 30 and the host secure logic unit 230 create a secure channel using the host key 232 (S120). When the secure channel is created, the memory secure logic unit 30 provides the secure data 14 associated with an ID key 12-2 of the memory device to the host secure logic unit 230 through the created secure channel. Then, the host secure logic unit 230 authenticates the memory device 100 (see FIG. 3) using the secure data 14 provided through the secure channel.

Referring again to FIG. 3, when the authentication is successful as an authentication result of the host secure logic unit 230, the host controller 240 provides, to the memory controller 40, an address associated with the content data stored in the second memory area 20 and a command requesting output thereof. In response thereto, the memory controller 40 provides the corresponding content data to the host device 200.

As described above, the memory system in accordance with this embodiment performs the authentication for the memory device 100 at a level of the memory device 100. In other words, the authentication for the memory device 100 is performed through the memory secure logic unit 30 disposed in the memory device 100. Accordingly, it is possible to improve the security provide by the memory system.

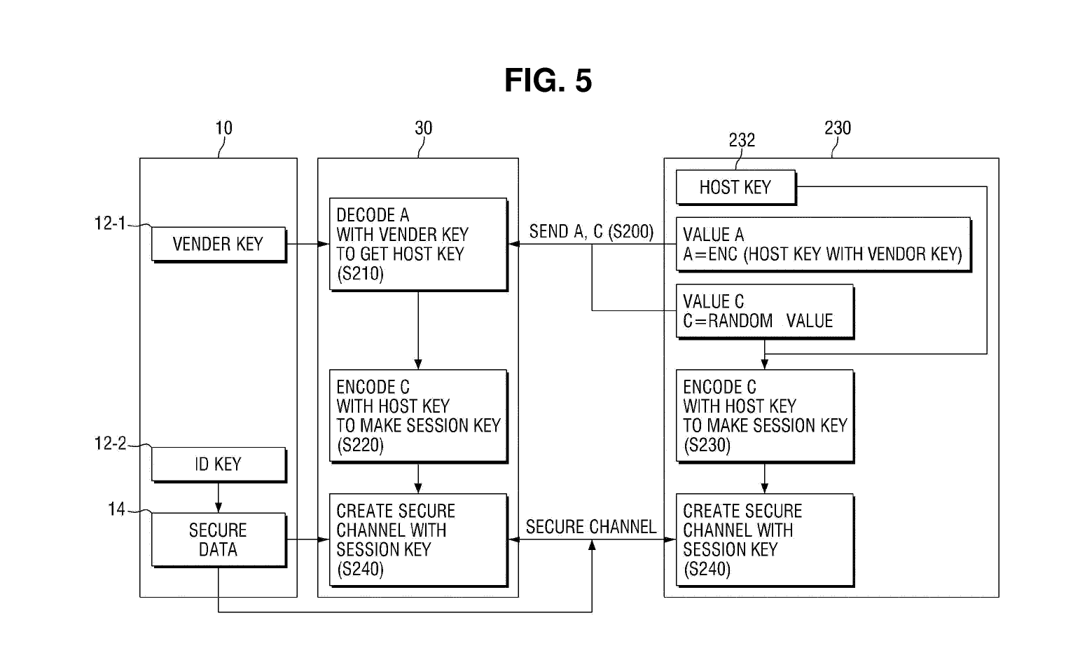

A method in which the host device 200 performs the authentication for the memory device 100 is not limited only to the above-described embodiment. If necessary, the authentication method may be modified. Hereinafter, operation of a memory system in accordance with certain embodiments of the inventive concept will be described with reference to FIG. 5.

FIG. 5 is a diagram for explaining an operation of a memory system in accordance with another embodiment of the inventive concept. Hereinafter, a repeated description of the same elements as those of the above-described embodiment will be omitted and only differences will be described.

Referring to FIG. 5, the host secure logic unit 230 transmits a first set value “A” and a second set value “C” to the memory secure logic unit 30 (S200). Here, the second set value C may be a random value that is changed whenever the value is provided to the memory secure logic unit 30. In order to generate the random value, the host secure logic unit 230 may further include a separate random value generator (not shown).

Upon receipt of the first set value A and the second set value C, first, the memory secure logic unit 30 acquires a host key by decoding (e.g., decrypting) the first set value A using the vender key 12-1 stored in the first memory area 10 (S210). Then, the memory secure logic unit 30 generates a session key by encoding (e.g., encrypting) the second set value C provided from the host secure logic unit 230 using the host key 232 previously acquired (S220).

The host secure logic unit 230 generates a session key by encoding (e.g., encrypting) the second set value C provided to the memory secure logic unit 30 using the host key 232 included in the host secure logic unit 230 (S230). In this embodiment, since the second set value C is a random value that is changed whenever the secure authentication is performed, the values of the session keys generated by the memory secure logic unit 30 and the host secure logic unit 230 may be also changed.

Thereafter, if both the memory secure logic unit 30 and the host secure logic unit 230 have the session keys, the secure channel is created using the session keys (S240). Then, the memory secure logic unit 30 transmits and receives the secure data 14 associated with the ID key 12-2 to and from the host secure logic unit 230, thereby performing the secure authentication for the memory device 100. Since the subsequent operation is the same as that of the above-described embodiment, a repeated description is omitted.

As described above, in this embodiment, the values of the session keys are changed whenever the secure authentication for the memory device 100 is performed. Accordingly, it is possible to enhance the reliability of security of the memory system.

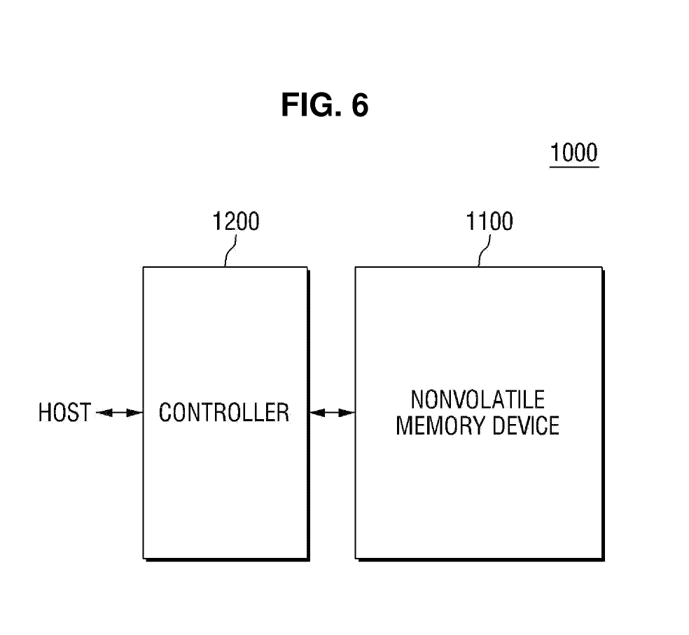

Hereinafter, a memory system in accordance with certain embodiments of the inventive concept and application examples thereof will be described with reference to FIGS. 6 to 8.

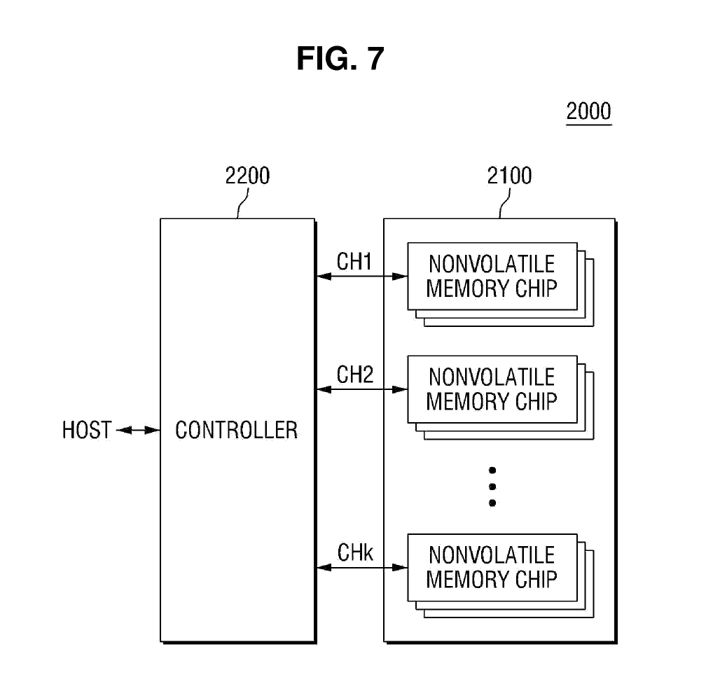

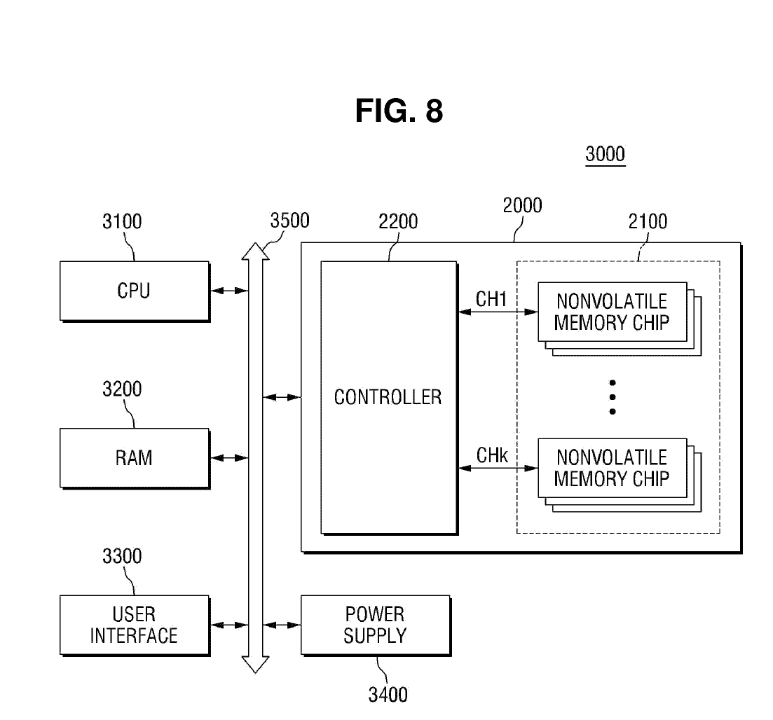

FIG. 6 is a block diagram illustrating a memory system in accordance with embodiments of the inventive concept. FIG. 7 is a block diagram illustrating an application example for the memory system of FIG. 6. And FIG. 8 is a block diagram illustrating a computational system including the memory system described with reference to FIG. 7.

Referring to FIG. 6, a memory system 1000 includes a nonvolatile memory device 1100 and a controller 1200.

The nonvolatile memory device 1100 may be a non-volatile memory device with improved reliability of security as described above.

The controller 1200 is connected to a host and the nonvolatile memory device 1100. In response to the request of the host, the controller 1200 is configured to access the nonvolatile memory device 1100. For example, the controller 1200 is configured to control the read, write, erase and background operations of the nonvolatile memory device 1100. The controller 1200 is configured to provide an interface between the nonvolatile memory device 1100 and the host. The controller 1200 is configured to operate a firmware for controlling the nonvolatile memory device 1100.

Specifically, the controller 1200 may further include well-known components such as a random access memory (RAM), a processing unit, a host interface, and a memory interface. The RAM is used as at least one of an operation memory of the processing unit, a cache memory between the nonvolatile memory device 1100 and the host, and a buffer memory between the nonvolatile memory device 1100 and the host. The processing unit controls all operations of the controller 1200.

The host interface includes a protocol for performing data exchange between the hose and the controller 1200. For example, the controller 1200 is configured to perform communication with the outside (host) through at least one of various interface protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, and an integrated drive electronics (IDE) protocol. The memory interface interfaces with the nonvolatile memory device 1100. For example, the memory interface includes a NAND interface or NOR interface.

The memory system 1000 may be configured to additionally include an error correction block. The error correction block is configured to detect and correct an error of data read from the nonvolatile memory device 1100 using an error correction code (ECC). As an example, the error correction block is provided a component of the controller 1200. The error correction block may be provided as a component of the nonvolatile memory device 1100.

The controller 1200 and the nonvolatile memory device 1100 may be integrated as one semiconductor device. Specifically, the controller 1200 and the nonvolatile memory device 1100 may be integrated as one semiconductor device to constitute a memory card. For example, the controller 1200 and the nonvolatile memory device 1100 may be integrated as one semiconductor device to constitute a memory card such as a PC card (personal computer memory card international association (PCMCIA)), a compact flash card (CF), a smart media card (SM, SMC), a memory stick, a multimedia card (MMC, RS-MMC, MMCmicro), a SD card (SD, miniSD, microSD, SDHC), a universal flash storage device (UFS) and the like.

The controller 1200 and the nonvolatile memory device 1100 may be integrated as one semiconductor device to constitute a semiconductor drive (solid state drive (SSD)). The semiconductor drive (SSD) includes a storage device configured to store data in a semiconductor memory. In a case where the memory system 1000 is used as the semiconductor drive (SSD), an operation speed of the host connected to the memory system 1000 is dramatically improved.

As another example, the memory system 1000 is provided as one of various components of an electronic apparatus such as a computer, ultra mobile PC (UMPC), workstation, net-book, personal digital assistants (PDA), portable computer, web tablet, wireless phone, mobile phone, smart phone, e-book, portable multimedia player (PMP), portable game console, navigation device, black box, digital camera, 3-dimensional television, digital audio recorder, digital audio player, digital picture recorder, digital picture player, digital video recorder, digital video player, apparatus capable of transmitting and receiving information in wireless environment, one of various electronic apparatuses constituting the home network, one of various electronic apparatuses constituting the computer network, one of various electronic apparatuses constituting the telematics network, RFID device, and one of various components forming the computing system.

Specifically, the nonvolatile memory device 1100 or the memory system 1000 may be mounted as various types of packages. For example, the nonvolatile memory device 1100 or the memory system 1000 may be mounted as a package such as package on package (PoP), ball grid arrays (BGAs), chip scale packages (CSPs), plastic leaded chip carrier(PLCC), plastic dual in line package (PDIP), die in waffle pack, die in wafer form, chip on board (COB), ceramic dual in line package (CERDIP), plastic metric quad flat pack (MQFP), thin quad flat pack (TQFP), small outline (SOIC), shrink small outline package (SSOP), thin small outline (TSOP), thin quad flat pack (TQFP), system in package (SIP), multi chip package (MCP), wafer-level fabricated package (WFP), wafer-level processed stack package (WSP).

Referring to FIG. 7, a memory system 2000 includes a nonvolatile memory device 2100 and a controller 2200. The nonvolatile memory device 2100 includes a plurality of nonvolatile memory chips. The nonvolatile memory chips are classified into a plurality of groups. Each group of the nonvolatile memory chips is configured to perform communication with the controller 2200 via one common channel. For example, the nonvolatile memory chips perform communication with the controller 2200 via first to k-th channels CH1 to CHk.

A case where a plurality of nonvolatile memory chips are connected to one channel has been illustrated in FIG. 7. However, it can be understood that the memory system 2000 may be modified such that one nonvolatile memory chip is connected to one channel.

Referring to FIG. 8, a computational system 3000 includes a central processing unit (CPU) 3100, a random access memory (RAM) 3200, a user interface 3300, a power supply 3400, and the memory system 2000.

The memory system 2000 is electrically connected to the central processing unit 3100, the RAM 3200, the user interface 3300 and the power supply 3400 via a system bus 3500. The data provided through the user interface 3300 or processed by the central processing unit 3100 is stored in the memory system 2000.

FIG. 8 illustrates a case where the nonvolatile memory device 2100 is connected to the system bus 3500 through the controller 2200. However, the nonvolatile memory device 2100 may be configured to be directly connected to the system bus 3500.

A case of providing the memory system 2000 described with reference to FIG. 7 has been illustrated in FIG. 8. However, the memory system 2000 may be replaced by the memory system 1000 described with reference to FIG. 6.

For instance, the computational system 3000 may be configured to include all of the memory systems 1000 and 2000 described with reference to FIGS. 6 and 7.

In concluding the detailed description, those skilled in the art will appreciate that many variations and modifications can be made to the preferred embodiments without substantially departing from the scope and principles of the inventive concept. Therefore, the disclosed preferred embodiments of the inventive concept are used in a generic and descriptive sense only and not for purposes of limitation.

What is claimed is:

1. A memory device comprising:
a first memory area that stores a secure key;
a second memory area that stores content data;
memory secure logic configured to exclusively access the secure key in the first memory area; and
a memory controller that accesses the content data in response to externally provided command, address and data (CAD) information and the secure key as accessed through the memory secure logic.

2. The memory device of claim 1, wherein the memory secure logic unit and the memory controller are commonly disposed within the memory device.

3. The memory device of claim 1, wherein the secure key is used during a self-encryption process performed on the content data.

4. The memory device of claim 3, wherein the memory secure logic is further configured to encrypt externally provided input data using the secure key to generate and provide corresponding encrypted input data to the memory controller.

5. The memory device of claim 1, wherein the secure key is at least one of a vender key and an identification (ID) key, and
the first memory area is further configured to store secure data associated with the ID key.

6. The memory device of claim 1, wherein the memory device includes a NAND flash.

7. A memory system comprising:
a memory device; and
a host device configured to access the memory device,
wherein the memory device comprises:
a first memory area that stores a secure key;
a second memory area that stores content data;
memory secure logic configured to exclusively access the secure key in the first memory area; and
a memory controller that accesses the content data in response to externally provided command, address and data (CAD) information and the secure key as accessed through the memory secure logic.

8. The memory system of claim 7, wherein the first memory area additionally stores secure data associated with the secure key, and
the host device comprises host secure logic configured to interoperate with the memory secure logic to create a secure channel that communicates the secure data between the memory device and the host device.

9. The memory system of claim 8, wherein the host secure logic is further configured to provide a host key and create the secure channel by communicating the host key to the memory secure logic.

10. The memory system of claim 9, wherein the host secure logic and memory secure logic are further configured to interoperate in response to the host key to create a session key controlling the secure channel.

11. A method of operating a memory system including a memory device, and a host device configured to access content data stored in the memory device, wherein the memory device includes a memory controller and memory secure logic physically separate from the memory controller, the method comprising:
storing a secure key in a first memory area of the memory device, and storing content data in a second memory area of the memory device;
communicating control, address and data (CAD) information from the host device to the memory controller; and
in response to the CAD information, using the memory controller to control operation of the memory secure logic to exclusively access the secure key, wherein access to the content data by the host device requires both the CAD information and execution of access rights granted by the secure key.

12. The method of claim 11, wherein the CAD information includes input data, and storing the content data comprises executing a self-encryption process using the memory secure logic on the input data to generate encrypted input data.

13. The method of claim 12, further comprising:
providing the encrypted input data to the memory controller, and using the memory controller to store the encrypted input data as the content data.

14. The method of claim 12, further comprising:
storing secure data associated with the secure key in the first memory area; and
creating a secure channel between the memory device and the host device to communicate the secure data.

15. The method of claim 14, further comprising:
providing a host key from the host device to the memory device to create the secure channel.

16. The method of claim 14, wherein creating the secure channel comprises:
receiving the host key from the host device,
generating a session key using the host key, and
creating the secure channel using the generated session key.

17. The method of claim 16, wherein the secure key includes a vender key and an ID key, and the method further comprises:
generating a first set value obtained by encoding the host key using the vender key, and generating a second set value different from the first set value,
wherein receiving the host key from the host secure logic unit comprises receiving the first set value and the second set value from the host device and decoding the first set value using the vender key.

18. The method of claim 16, wherein generating the session key using the host key includes generating the session key by encoding the second set value using the host key.

19. The method of claim 16, wherein the second set value is changed whenever a value is provided to the memory secure logic unit.

20. The method of claim 11, wherein the host device receives the secure data through the secure channel, performs authentication, and provides a command to the memory controller after authentication.
